(19) United States
(12) Patent Application Publication
(10) Pub. No.: US 2011/0050911 A1
(43) Pub. Date: Mar. 3, 2011

(54) IMAGE CAPTURING DEVICE AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/631,947

(22) Filed: Dec. 7, 2009

(30) Foreign Application Priority Data
Aug. 26, 2009 (CN) 200910306102.5

(51) Int. Cl. H04N 5/225; G03B 41/00

(52) U.S. Cl. 348/207.1; 396/332; 348/E05.024

(57) ABSTRACT

A method for capturing images includes setting a capturing mode and a monitor time of a plurality of lenses of an image capturing device, controlling each lens to capture images at the same time when the monitor time arrives. The method further captures a plurality of images based on different focal lengths or from different angles at the same time, and sends the plurality of images to a monitor computer.

### BACKGROUND

1. Technical Field

Embodiments of the present disclosure relate to image capturing technology, and particularly to an image capturing device and method.

2. Description of Related Art

In recent years, image capturing devices have been used to perform security surveillance by capturing images of specified space, and sending the captured images to a surveillance monitoring computer. However, an image capturing device typically only has one lens, thus, the image capturing device can only capture images based on single focal length at a single angle at the same time. As a result, for example, the faces of a person in the captured images may be badly out of focus (i.e., be very blurred). Therefore, prompt and accurate image capturing method of the specified space is desirable.

### BRIEF DESCRIPTION OF THE DRAWINGS

FIG. 1 is a schematic diagram of one embodiment of a structure of a plurality of lens of an image capturing device in a single level mode.

FIG. 2 is a schematic diagram of one embodiment of a structure of the plurality of lens of the image capturing device in a cylindrical mode.

FIG. 3 is a schematic diagram of one embodiment of a structure of the plurality of lens of the image capturing device in a spherical mode.

FIG. 4 is a flowchart of one embodiment of a method for capturing images.

### DETAILED DESCRIPTION

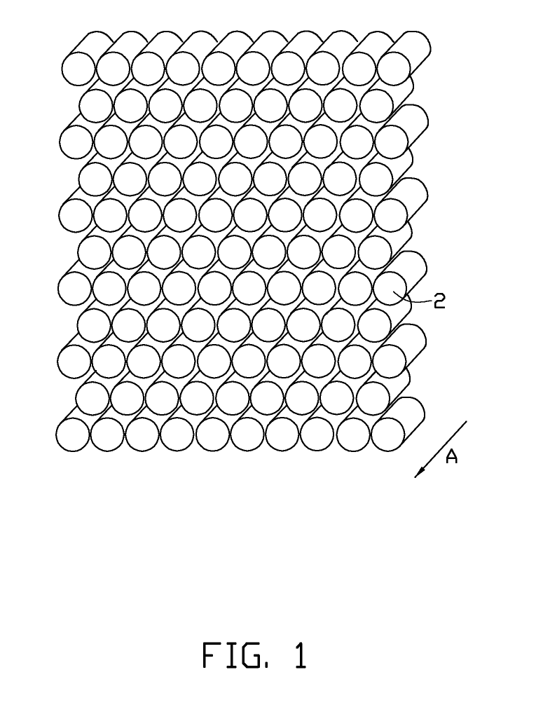

FIG. 1 is a schematic diagram of one embodiment of a structure of a plurality of lenses 2 of an image capturing device in a single level mode. In the single level mode, the plurality of lenses 2 of the image capturing device are aligned on the same plane, and the focal lengths of each of the lenses 2 are different. Referring to FIG. 1, a direction of an arrow “A” represents a capturing direction of the plurality of lenses 2. In one embodiment, the image capturing device includes more than two lenses 2.

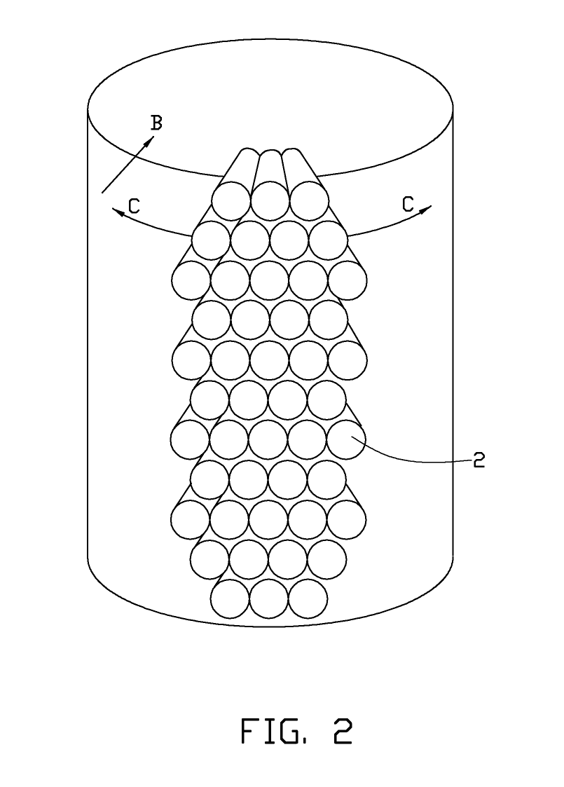

FIG. 2 is a schematic diagram of one embodiment of a structure of a plurality of lenses 2 of an image capturing device in a cylindrical mode. In the cylindrical mode, the plurality of lenses 2 of the image capturing device are aligned cylindrically. Furthermore, the focal lengths of each of the lenses 2 are different. Referring to FIG. 2, a direction of an arrow “B” represents a capturing direction of the plurality of lenses 2, a direction of an arrow “C” represents an aligned direction of the plurality of lenses 2 in the cylindrical mode.

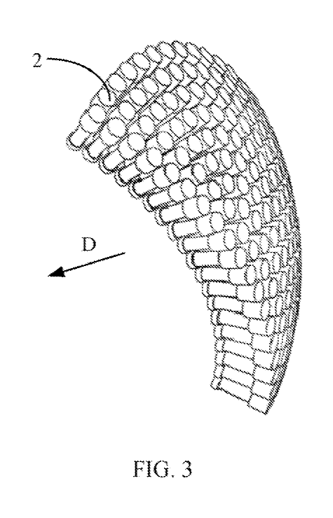

FIG. 3 is a schematic diagram of one embodiment of a structure of a plurality of lenses 2 of an image capturing device in a spherical mode. In the spherical mode, the plurality of lenses 2 of the image capturing device are aligned spherically. Furthermore, the focal lengths of each of the lenses 2 are different. Referring to FIG. 3, a direction of an arrow “D” represents a capturing direction of the plurality of lenses 2.

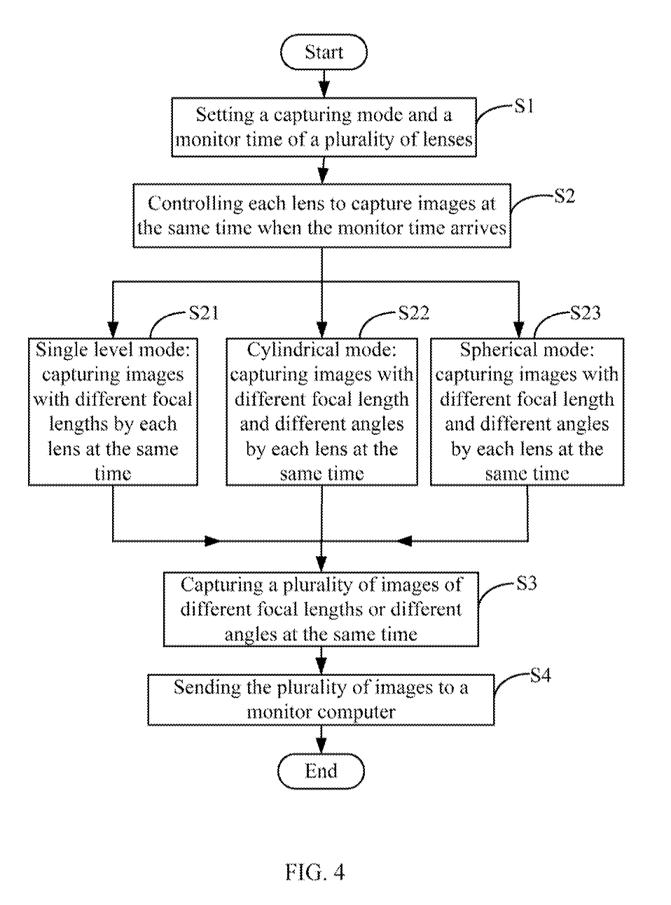

FIG. 4 is a flowchart of one embodiment of a method for capturing images. Depending on the embodiment, additional blocks may be added, others removed, and the ordering of the blocks may be changed.

In block S1, a capturing mode and a monitor time of the plurality of lenses 2 of the image capturing device are set. In one embodiment, the capturing mode of the plurality of lenses 2 may be a single level mode (refers to FIG. 1), a cylindrical mode (refers to FIG. 2), or a spherical mode (refers to FIG. 3). In the cylindrical mode and the spherical mode, the plurality of lenses 2 of the image capturing device are aligned on the same curved surface.

In block S2, the image capturing device controls each lens 2 to capture images at the same time when the monitor time arrives. Block S21 is processed if the capturing mode of the plurality of lenses 2 is the single level mode. Block S22 is processed if the capturing mode of the plurality of lenses 2 is the cylindrical mode. Block S23 is processed if the capturing mode of the plurality of lenses 2 is the spherical mode.

In block S21, the plurality of lenses 2 of the image capturing device capture images with different focal lengths at the same time.

In block S22, the plurality of lenses 2 of the image capturing device capture images with different focal lengths from different angles at the same time.

In block S23, the plurality of lenses 2 of the image capturing device capture images with different focal lengths from different angles at the same time.

In block S3, a plurality of images of different focal lengths or from different angles are captured at the same time by the plurality of lenses 2 of the image capturing device. A detailed description is as follows. If the plurality of lenses 2 of the image capturing device are aligned on the same plane (i.e., in the single level mode), a plurality of images of different focal lengths are captured at the same time by the plurality of lenses 2 of the image capturing device. If the plurality of lenses 2 of the image capturing device are aligned on the same curved surface (i.e., in the cylindrical or spherical mode), a plurality of images of different focal lengths from different angles are captured at the same time by the plurality of lenses 2 of the image obtaining device.

In block S4, the image capturing device sends the plurality of images to a monitor computer for security monitoring purposes.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An image capturing device for capturing images, the image capturing device comprising a plurality of lenses, wherein the plurality of lenses are aligned on a same plane or a same curved surface, and focal lengths of each of the plurality of lenses are different.

2. The image capturing device according to claim 1, wherein the plurality of lenses on the same curved surface are aligned in a cylindrical mode or a spherical mode.

3. The image capturing device according to claim 2, wherein the plurality of lenses of the image capturing device are aligned cylindrically in the cylindrical mode.

4. The image capturing device according to claim 2, wherein the plurality of lenses of the image capturing device are aligned spherically in the spherical mode.

5. A method for capturing images, comprising:
providing an image capturing device comprising a plurality of lenses, wherein the plurality of lenses are aligned on a same plane or a same curved surface, and focal lengths of each of the plurality of lenses are different;
setting a capturing mode and a monitor time of the plurality of lenses;
controlling each lens of the image capturing device to capture images at the same time when the monitor time arrives; and
capturing a plurality of images based on different focal lengths or from different angles at the same time by the plurality of lenses of the image capturing device.

6. The method according to claim 5, further comprising: sending the plurality of images to a monitor computer.

7. The method according to claim 5, wherein the plurality of lenses on the same curved surface are aligned in a cylindrical mode or a spherical mode.

8. The method according to claim 7, wherein the plurality of lenses of the image capturing device are aligned cylindrically in the cylindrical mode.

9. The method according to claim 7, wherein the plurality of lenses of the image capturing device are aligned spherically in the spherical mode.

10. The method according to claim 5, wherein controlling each lens of the image capturing device to capture images at the same time comprises:
capturing images with different focal lengths by each lens of the image capturing device at the same time if the plurality of lenses of the image capturing device are aligned on the same plane; and
capturing images with different focal lengths from different angles by each lens of the image capturing device at the same time if the plurality of lenses are aligned on the same curved surface.
